(19) United States
(12) Patent Application Publication
(10) Pub. No.: US 2025/0182957 A1
(43) Pub. Date: Jun. 5, 2025

(54) COIL COMPONENT

(71) Applicant: TAIYO YUDEN CO., LTD., Tokyo (JP)

(72) Inventors: Natsuko SATO, Tokyo (JP); Shinya AKIYAMA, Tokyo (JP)

(21) Appl. No.: 18/955,110

(22) Filed: Nov. 21, 2024

(30) Foreign Application Priority Data
Nov. 30, 2023 (JP) 2023-203123

(51) Int. Cl. H01F 27/34; H01F 27/28

(52) U.S. Cl. CPC H01F 27/34; H01F 27/2804; H01F 27/2852; H01F 2027/2809

(57) ABSTRACT

One object is to inhibit magnetic flux from concentrating in the region of the base body near the end of the inner peripheral surface of the coil conductor in the height direction. A coil component in one aspect includes a base body containing metal magnetic particles and a coil conductor including a winding portion. The base body includes a core portion positioned inside the winding portion, one end portion covering one end surface of the winding portion, and another end portion covering another end surface of the winding portion. The core portion includes a core center portion at the center. An average particle size of metal magnetic particles contained in the one end portion and an average particle size of metal magnetic particles contained in the other end portion are smaller than an average particle size of metal magnetic particles contained in the core center portion.

### CROSS-REFERENCE TO RELATED APPLICATIONS

This application is based on and claims the benefit of priority from Japanese Patent Application Serial No. 2023-203123 (filed on Nov. 30, 2023), the contents of which are hereby incorporated by reference in their entirety.

### TECHNICAL FIELD

The present disclosure relates to a coil component.

### BACKGROUND

There are conventional coil components including a base body formed of a magnetic material, an external electrode provided on the surface of the base body, and a coil conductor extending around a coil axis in the base body.

One example of coil components is an inductor. An inductor is a passive element used in an electronic circuit. For example, an inductor eliminates noise in a power source line or a signal line.

An inductor is disclosed in Japanese Patent Application Publication No. 2018-121023, in which a base body includes a magnetic gap layer provided therein to prevent magnetic saturation in the base body and improve the DC superimposition characteristics.

As electronic devices are downsized, there are higher demands for a reduced thickness (or lower profile) of coil components incorporated in the electronic components.

The inventor discovered that when the coil component has a lower profile, the magnetic flux significantly concentrates in the region of the base body near the end of the inner peripheral surface of the coil conductor in the height direction. When magnetic flux concentrates in a part of the base body, magnetic loss undesirably increases in the area where the magnetic flux concentrates.

### SUMMARY

One object of the present disclosure is to provide a coil component capable of inhibiting the magnetic flux from concentrating in the region of the base body near the end of the inner peripheral surface of the coil conductor in the height direction.

Other objects of the present disclosure will be made apparent through the entire description in the specification. The inventions recited in the claims may also address any other drawbacks in addition to the above drawback.

A coil component according to one embodiment includes: a base body containing a plurality of metal magnetic particles; and a coil conductor. The coil conductor includes a winding portion provided in the base body and wound around a coil axis. The base body includes a core portion, one end portion, and another end portion, the core portion being positioned inside the winding portion in a radial direction around the coil axis, the one end portion covering one end surface of the winding portion, the other end portion covering another end surface of the winding portion. The core portion includes a core center portion at the center in the axial direction. A first average particle size, which indicates an average particle size of first metal magnetic particles contained in the one end portion among the plurality of metal magnetic particles, and a second average particle size, which indicates an average particle size of second metal magnetic particles contained in the other end portion, are smaller than a third average particle size, which indicates an average particle size of third metal magnetic particles contained in the core center portion.

### Advantageous Effects

The embodiments of the invention disclosed herein provide a coil component capable of inhibiting the magnetic flux from concentrating in the region of the base body near the end of the inner peripheral surface of the coil conductor in the height direction.

### BRIEF DESCRIPTION OF THE DRAWINGS

FIG. 1 is a perspective view schematically showing a coil component according to a first embodiment.

FIG. 2 is a sectional view schematically showing a section of the coil component of FIG. 1 cut along the line I-I.

FIG. 3A is a plan view showing one of conductor patterns included in the coil component of FIG. 1.

FIG. 3B is a plan view showing another of conductor patterns included in the coil component of FIG. 1.

FIG. 3C is a plan view showing still another of conductor patterns included in the coil component of FIG. 1.

FIG. 3D is a plan view showing still another of conductor patterns included in the coil component of FIG. 1.

FIG. 3E is a plan view showing still another of conductor patterns included in the coil component of FIG. 1.

FIG. 4 schematically shows flows of magnetic flux in the coil component of FIG. 1.

FIG. 5 shows a variation of the coil component of FIG. 1.

FIG. 6 schematically shows flows of magnetic flux in the coil component of FIG. 5.

FIG. 7 is a perspective view schematically showing a coil component according to another embodiment.

FIG. 8 is a sectional view schematically showing a section of the coil component of FIG. 5 cut along the line II-II.

FIG. 9 shows a variation of the coil component of FIG. 5.

### DESCRIPTION OF THE PREFERRED EMBODIMENTS

Various embodiments of the disclosure will be described hereinafter with reference to the appended drawings. Throughout the drawings, the same components are denoted by the same reference numerals. For convenience of explanation, the drawings are not necessarily drawn to scale. The following embodiments of the present invention do not limit the scope of the claims. The elements included in the following embodiments are not necessarily essential to solve the problem addressed by the invention.

### (1) First Embodiment

### (1-1) Basic Structure of Coil Component

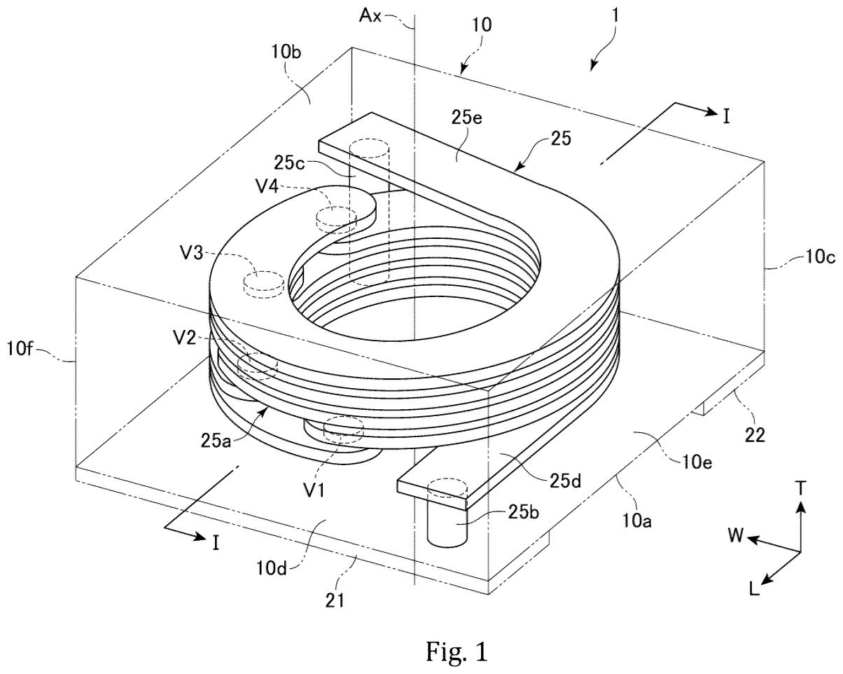

Referring to FIG. 1, the basic structure of a coil component 1 according to a first embodiment will now be described. FIG. 1 is a perspective view showing the coil component 1 according to the first embodiment.

The coil component 1 is a passive element used in an electronic circuit. For example, the coil component 1 is used to eliminate noise in power source lines or signal lines.

The coil component 1 shown in FIG. 1 includes a base body 10, a coil conductor 25 provided in the base body 10, a first external electrode 21 connected to one end of the coil conductor 25, and a second external electrode 22 connected to the other end of the coil conductor 25.

The coil component 1 may be mounted on a circuit board (not shown). The circuit board has land portions provided thereon. The coil component 1 is mounted on the mounting substrate by bonding the first external electrode 21 and the second external electrode 22 to the land portions. The circuit board having the coil component 1 mounted thereon can be installed in various electronic devices. The electronic devices in which the circuit board can be installed include smartphones, tablets, game consoles, electrical components of automobiles, servers, and various other electronic devices.

### (1-2) Basic Structure of Base Body 10

In one aspect, the base body 10 is formed of an insulating material into a rectangular parallelepiped shape. For example, the coil component 1 has a dimension in the L-axis direction (length) of 0.5 mm to 6.0 mm, a dimension in the W-axis direction (width) of 0.3 mm to 4.5 mm, and a dimension in the T-axis direction (height) of 0.3 mm to 3.0 mm. In one aspect, the height of the base body 10 is smaller than both the length and the width of the same. The height of the base body 10 may be smaller than 1.0 mm. The term “rectangular parallelepiped” or “rectangular parallelepiped shape” used herein is not intended to mean solely “rectangular parallelepiped” in a mathematically strict sense. As described later, the corners and/or edges of the base body 10 may be rounded. The dimensions and the shape of the base body 10 are not limited to those specified herein.

The base body 10 has a first principal surface 10a, a second principal surface 10b, a first end surface 10c, a second end surface 10d, a first side surface 10e, and a second side surface 10f. Each of the first end surface 10c, the second end surface 10d, the first side surface 10e, and the second side surface 10f is connected to the first principal surface 10a and the second principal surface 10b. The first end surface 10c connects between the first side surface 10e and the second side surface 10f. The second end surface 10d also connects between the first side surface 10e and the second side surface 10f. The first principal surface 10a and the second principal surface 10b are at the opposite ends in the height direction of the base body 10, the first end surface 10c and the second end surface 10d are at the opposite ends in the length direction of the base body 10, and the first side surface 10e and the second side surface 10f are at the opposite ends in the width direction of the base body 10. As shown in FIG. 1, the first principal surface 10a is at the bottom of the base body 10, and therefore, the first principal surface 10a may be referred to as a “lower surface” or “bottom surface.” Likewise, the second principal surface 10b may be referred to as a “top surface.”

In the embodiment shown, the first principal surface 10a of the base body 10 has the first external electrode 21 and the second external electrode 22 provided thereon. When the coil component 1 is mounted on the mounting substrate, the first principal surface 10a faces the mounting substrate. Therefore, the first principal surface 10a of the base body 10 may be herein referred to as “the mounting surface.” At least one of the first and second external electrodes 21 and 22 may extend to any of the surfaces of the base body 10 other than the bottom surface 10a. For example, the first external electrode 21 may extend to contact the first end surface 10c as well as the bottom surface 10a.

The bottom surface 10a and the top surface 10b are separated from each other by a distance equal to the height of the base body 10, the first end surface 10c and the second end surface 10d are separated from each other by a distance equal to the length of the base body 10, and the first side surface 10e and the second side surface 10f are separated from each other by a distance equal to the width of the base body 10. In this specification, a “length” direction, a “width” direction, and a “thickness” direction of the coil component 1 correspond to the L-axis direction, the W-axis direction, and the T-axis direction in FIG. 1, respectively, unless otherwise construed from the context.

The base body 10 is made of an insulating material having an excellent insulation property. The base body 10 may be made of a magnetic material. The base body 10 may contain a plurality of metal magnetic particles. The metal magnetic particles contained in the base body 10 may be particles of (1) metals such as Fe or Ni, (2) alloys such as Fe—Si—Cr, Fe—Si—Al, or Fe—Ni, (3) amorphous materials such as Fe—Si—Cr—B—C or Fe—Si—B—Cr, or (4) a mixture of these materials. The material for the base body 10 may be a composite magnetic material including magnetic particles dispersed in a resin, a ferrite material, or any other known magnetic materials.

### (1-3) Basic Structure of Coil Conductor 25

The coil conductor 25 includes a winding portion 25a, a first lead-out portion 25b, a second lead-out portion 25c, a first connecting portion 25d connecting between one end of the winding portion 25a and the first lead-out portion 25b, and a second connecting portion 25e connecting between the other end of the winding portion 25a and the second lead-out portion 25c.

The winding portion 25a extends in a circumferential direction around a coil axis Ax extending along the Taxis. In the embodiment shown, the coil axis Ax extends along the axial direction parallel with the Taxis. The coil axis Ax is not necessarily parallel with the Taxis. The coil axis Ax intersects the top surface 10b and the bottom surface 10a of the base body 10. In the embodiment shown, the coil axis Ax passes through the intersection of the diagonal lines of the first principal surface 10a, which is rectangularly shaped as seen from above, and extends perpendicularly to the first principal surface 10a.

One end of the first lead-out portion 25b is connected with the first connecting portion 25d, and the first lead-out portion 25b extends downward along the T axis from the connecting position at which the first lead-out portion 25b connects with the first connecting portion 25d. The other end of the first lead-out portion 25b is exposed to the outside of the base body 10 through the bottom surface 10a. The other end of the first lead-out portion 25b, exposed through the bottom surface 10a, is connected with the first external electrode 21.

One end of the second lead-out portion 25c is connected with the second connecting portion 25e, and the second lead-out portion 25c extends downward along the Taxis from the connecting position at which the second lead-out portion 25c connects with the second connecting portion 25e. The other end of the second lead-out portion 25c is exposed to the outside of the base body 10 through the bottom surface 10a. The other end of the second lead-out portion 25c, exposed through the bottom surface 10a, is connected with the second external electrode 22.

The surface of the coil conductor 25 may be covered by an insulating film (not shown) composed of insulating material having an excellent insulation property. The insulating film may be an oxide film formed on the surface of the coil conductor 25 during the heat treatment in the manufacturing process of the coil component 1. The insulating film may be a coating film composed of resin having an excellent insulation property, such as polyurethane, polyamide imide, polyimide, polyester, polyester imide.

### (1-4) Detailed Description of Coil Component 1

### (1-4-1) Description of Base Body 10

In one embodiment, the base body 10 is a laminate formed of a plurality of magnetic films stacked together. As described later, the base body 10 may be a laminate of magnetic films, some of which having conductor patterns forming the winding portion 25a on the surface.

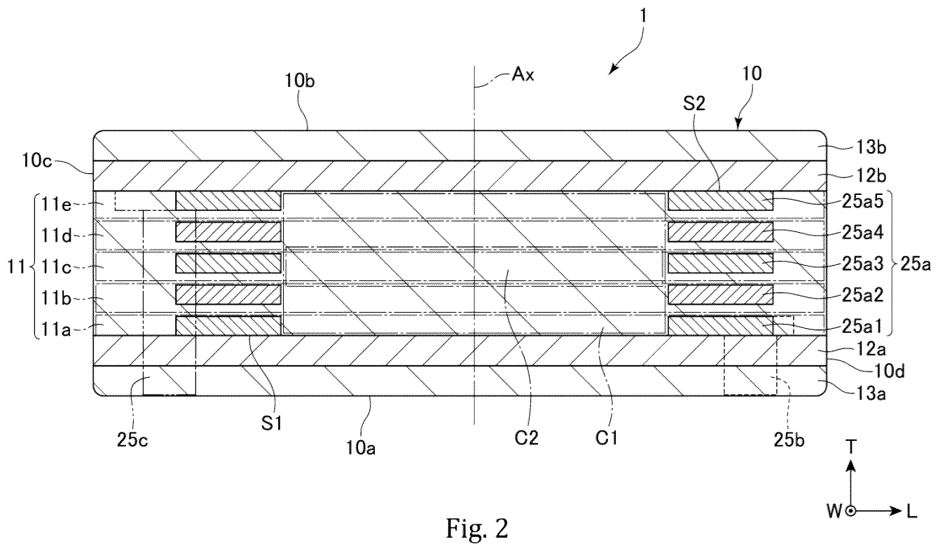

FIG. 2 is a sectional view schematically showing a section of the coil component 1 cut along the line I-I. FIG. 2 shows a section of the coil component 1 cut along a plane passing through the coil axis Ax and parallel to the LT plane. As shown in FIG. 2, the magnetic films constituting the base body 10 include magnetic films 11a, 11b, 11c, 11d, and 11e. However, the boundaries between the magnetic films 11a to 11e may not be visible even when a section of the base body 10 is observed under SEM.

Each of the magnetic films 11a to 11e has a conductor pattern formed on the top surface thereof, and these conductor patterns constitute the winding portion 25a. The region of the base body 10 that is formed of the laminate of the magnetic films 11a to 11e is herein referred to as the body portion 11. The region of the body portion 11 that is inside the inner peripheral surface of the winding portion 25a in the radial direction around the coil axis Ax is referred to as the core portion C1. In the illustrated embodiment, the portions of the magnetic films 11a to 11e that are radially inside the inner peripheral surface of the winding portion 25a constitute the core portion C1. The portion of the core portion C1 that includes the center of the core portion C1 in the axial direction along the coil axis Ax is referred to as the core center portion C2. In the illustrated embodiment, the portion of the magnetic film 11c that is radially inside the inner peripheral surface of the winding portion 25a constitutes the core center portion C2. The relative permeability of the core center portion C2 is herein referred to as the core center portion relative permeability.

In the base body 10, the body portion 11 has one end portion 12a provided on the bottom surface thereof. The one end portion 12a has a first relative permeability lower than the core center portion relative permeability of the core center portion C2. For this reason, the one end portion 12a may be herein referred to as the first low permeability portion 12a. Since one end surface S1 of the winding portion 25a is exposed through the bottom surface of the body portion 11, the first low permeability portion 12a is located between the one end surface S1 of the winding portion 25a and the bottom surface 10a of the base body 10. The first low permeability portion 12a covers the one end surface S1 of the winding portion 25a. The one end surface S1 of the winding portion 25a is one of the end surfaces of the winding portion 25a in the axial direction along the coil axis Ax. In the illustrated embodiment, the one end surface S1 of the winding portion 25a is the bottom surface of the winding portion 25a. In the illustrated embodiment, the first low permeability portion 12a extends in the LW plane from the first end surface 10c to the second end surface 10d of the base body 10 and from the first side surface 10e to the second side surface 10f of the base body 10. In other words, the first low permeability portion 12a defines a part of the first end surface 10c, the second end surface 10d, the first side surface 10e, and the second side surface 10f of the base body.

In the base body 10, the body portion 11 has the other end portion 12b provided on the top surface thereof. The other end portion 12a has a second relative permeability lower than the core center portion relative permeability of the core center portion C2. For this reason, the other end portion 12b may be herein referred to as the second low permeability portion 12b. Since the other end surface S2 of the winding portion 25a is exposed through the top surface of the body portion 11, the second low permeability portion 12b is located between the other end surface S2 of the winding portion 25a and the top surface 10b of the base body 10. The second low permeability portion 12b covers the other end surface S2 of the winding portion 25a. The other end surface S2 of the winding portion 25a is the surface opposed to the one end surface S1 of the winding portion 25a in the axial direction along the coil axis Ax. In the illustrated embodiment, the other end surface S2 of the winding portion 25a is the top surface of the winding portion 25a. In the illustrated embodiment, the second low permeability portion 12b extends in the LW plane from the first end surface 10c to the second end surface 10d of the base body 10 and from the first side surface 10e to the second side surface 10f of the base body 10. In other words, the second low permeability portion 12b defines a part of the first end surface 10c, the second end surface 10d, the first side surface 10e, and the second side surface 10f of the base body.

In one aspect, the relative permeability of the region of the core portion C1 other than the core center portion C2 (the region constituted by the magnetic films 11a, 11b, 11d, and 11e) may be equal to the first relative permeability. In another aspect, the relative permeability of the region of the core portion C1 other than the core center portion C2 may be equal to the second relative permeability. In still another aspect, the relative permeability of the region of the core portion C1 other than the core center portion C2 may be equal to the core center portion relative permeability.

In one aspect, the base body 10 contains a plurality of metal magnetic particles, and adjacent metal magnetic particles are bonded to each other via an insulating layer or bonding material formed on the surface of each particle. In one aspect, the first average particle size, which indicates the average particle size of the metal magnetic particles contained in the first low permeability portion 12a, and the second average particle size, which indicates the average particle size of the metal magnetic particles contained in the second low permeability portion 12b, are smaller than the third average particle size, which indicates the average particle size of the metal magnetic particles contained in the core center portion C2. In one aspect, the first and second average particle sizes are in the range of 1/10 to ½ of the third average particle size. On the other hand, the filling factor of the metal magnetic particles in the first low permeability portion 12a and the second low permeability portion 12b is about the same as that in the core center portion C2. The filling factor of the metal magnetic particles in the first low permeability portion 12a and the second low permeability portion 12b is 0.8 to 1.2 times as high as that in the core center portion C2. Since the filling factor of the metal magnetic particles in the first low permeability portion 12a and the second low permeability portion 12b is about the same as that in the core center portion C2, and the first and second average particle sizes are smaller than the third average particle size, the first relative permeability of the first low permeability portion 12a and the second relative permeability of the second low permeability portion 12b can be lower than the core center portion relative permeability of the core center portion C2.

The “average particle size” of the metal magnetic particles in this specification are determined in the following manner. The base body 10 is cut along the thickness direction (the T-axis direction) to expose a sectional surface. The sectional surface is photographed using a scanning electron microscope (SEM) to obtain an SEM image at 1000 to 5000-fold magnification, and the particle size distribution is determined based on the SEM image. The particle size distribution obtained in this way is used to determine the average particle size. For example, the 50th percentile (D50) of the particle size distribution obtained based on the SEM image can be used as the average particle size of the metal magnetic particles. When determining the average particle size of the metal magnetic particles contained in the first low permeability portion 12a, the region corresponding to the first low permeability portion 12a in the section of the base body 10 is observed. When determining the average particle size of the metal magnetic particles contained in the second low permeability portion 12b, the region corresponding to the second low permeability portion 12b in the section of the base body 10 is observed.

In one aspect, the first relative permeability of the first low permeability portion 12a is about the same as the second relative permeability of the second low permeability portion 12b. For example, the first relative permeability is 0.8 to 1.2 times as high as the second relative permeability. In another aspect, the first relative permeability may be lower than the second relative permeability.

The base body 10 includes a first cover portion 13a provided opposite to the core portion C1 with respect to the first low permeability portion 12a in the axial direction. In the illustrated embodiment, the first cover portion 13a is provided on the bottom surface of the first low permeability portion 12a. The first cover portion 13a has a third relative permeability higher than the first relative permeability of the first low permeability portion 12a. In the illustrated embodiment, the first cover portion 13a defines a part of the first end surface 10c, the second end surface 10d, the first side surface 10e, and the second side surface 10f and the entirety of the bottom surface 10a of the base body 10.

The base body 10 includes a second cover portion 13b provided opposite to the core portion C1 with respect to the second low permeability portion 12b in the axial direction. In the illustrated embodiment, the second cover portion 13b is provided on the top surface of the second low permeability portion 12b. The second cover portion 13b has a fourth relative permeability higher than the second relative permeability of the second low permeability portion 12b. In the illustrated embodiment, the second cover portion 13b defines a part of the first end surface 10c, the second end surface 10d, the first side surface 10e, and the second side surface 10f and the entirety of the top surface 10b of the base body 10.

### (1-4-2) Detailed Description of Coil Conductor

Each of the magnetic films 11a to 11e has a conductor pattern formed on the top surface thereof, and these conductor patterns constitute a part of the coil conductor 25. Each of the magnetic films 11a to 11e has a through hole formed at a predetermined position to extend through the magnetic film in the T-axis direction, and the via conductors are embedded in these through holes. The conductor patterns and the via conductors of the coil component 1 are formed as follows: a conductive paste formed of a metal or an alloy having an excellent conductivity is printed by screen printing on magnetic sheets that are precursors of the magnetic films 11a to 11e, and the conductive paste printed on the magnetic sheets is heated. The conductive paste may be made of Ag, Pd, Cu, Al, or alloys thereof. The conductor patterns and the via conductors of the coil component 1 may be formed of materials other than those described above. For example, the conductor patterns and the via conductors of the coil component 1 may be formed by sputtering, ink-jetting, or other known methods.

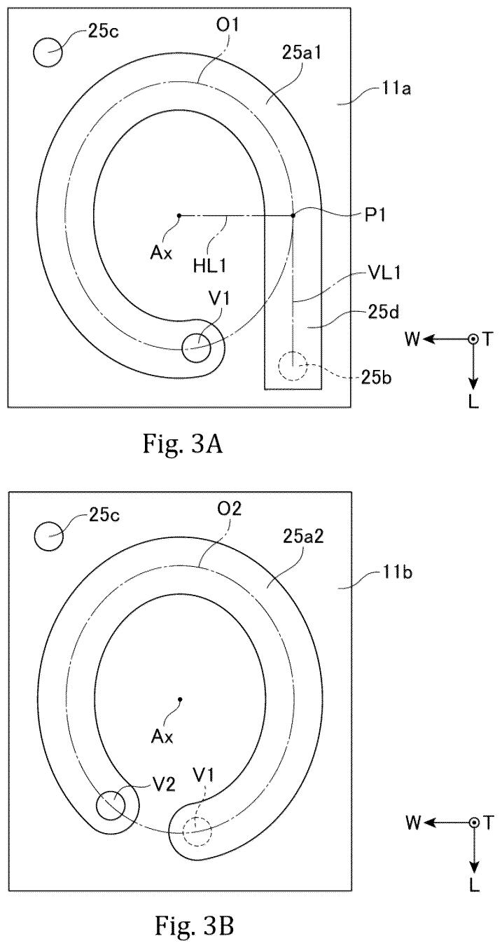

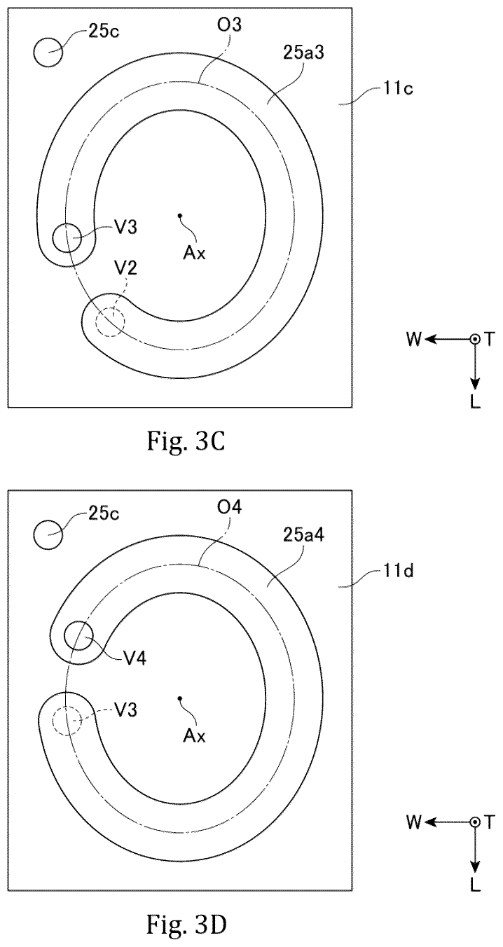

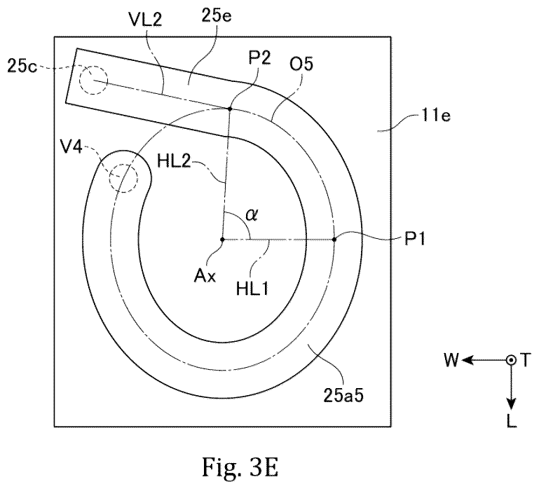

The conductor patterns formed on the top surfaces of the magnetic films are further described with reference to FIGS. 3A to 3E. FIG. 3A shows the first conductor pattern 25a1 constituting a part of the winding portion 25a and the first connecting portion 25d, FIGS. 3B to 3D show the second, third, and fourth conductor patterns 25a2, 25a3, and 25a4 constituting a part of the winding portion 25a, and FIG. 3E shows the fifth conductor pattern 25a5 constituting a part of the winding portion 25a and the second connecting portion 25e.

As shown in FIG. 3A, the first conductor pattern 25a1, which is included in the winding portion 25a, and the first connecting portion 25d are formed on the top surface of the magnetic film 11a. The first conductor pattern 25a1 extends along a first track 01 having an elliptical shape and encircling the coil axis Ax. The first connecting portion 25d extends straight along the L-axis direction between the first conductor pattern 25a1 and the first lead-out portion 25b. The first conductor pattern 25a1 extends along the first track 01 around the coil axis Ax for one turn or less. The first connecting portion 25d diverts from the first track 01 and extends straight. The first conductor pattern 25a1 is connected at one end P1 thereof to the first connecting portion 25d and is connected at the other end thereof to the via conductor V1.

As shown in FIG. 3B, the second conductor pattern 25a2, which constitutes a part of the winding portion 25a, is formed on the top surface of the magnetic film 11b. The second conductor pattern 25a2 extends along a second track 02 having an elliptical shape and encircling the coil axis Ax. The second conductor pattern 25a2 extends along the second track 02 around the coil axis Ax for one turn or less. The second conductor pattern 25a2 is connected at one end thereof to the via conductor V1 and is connected at the other end thereof to the via conductor V2. The magnetic film 11b has a through hole extending therethrough in the T-axis direction at the region overlapping with the via conductor V1, and the via conductor V1 is embedded in this through hole.

As shown in FIG. 3C, the third conductor pattern 25a3, which constitutes a part of the winding portion 25a, is formed on the top surface of the magnetic film 11c. The third conductor pattern 25a3 extends along a third track 03 having an elliptical shape and encircling the coil axis Ax. The third conductor pattern 25a3 extends along the third track 03 around the coil axis Ax for one turn or less. The third conductor pattern 25a3 is connected at one end thereof to the via conductor V2 and is connected at the other end thereof to the via conductor V3. The magnetic film 11c has a through hole extending therethrough in the T-axis direction at the region overlapping with the via conductor V2, and the via conductor V2 is embedded in this through hole.

As shown in FIG. 3D, the fourth conductor pattern 25a4, which constitutes a part of the winding portion 25a, is formed on the top surface of the magnetic film 11d. The fourth conductor pattern 25a4 extends along a fourth track 04 having an elliptical shape and encircling the coil axis Ax. The fourth conductor pattern 25a4 extends along the fourth track 04 around the coil axis Ax for one turn or less. The fourth conductor pattern 25a4 is connected at one end thereof to the via conductor V3 and is connected at the other end thereof to the via conductor V4. The magnetic film 11d has a through hole extending therethrough in the T-axis direction at the region overlapping with the via conductor V3, and the via conductor V3 is embedded in this through hole.

As shown in FIG. 3E, the fifth conductor pattern 25a5, which constitutes a part of the winding portion 25a, and the second connecting portion 25e are formed on the top surface of the magnetic film 11e. The fifth conductor pattern 25a5 extends along a fifth track 05 having an elliptical shape and encircling the coil axis Ax. The second connecting portion 25e extends straight between the fifth conductor pattern 25a5 and the second lead-out portion 25c. The fifth conductor pattern 25a5 extends along the fifth track 05 around the coil axis Ax for one turn or less. The fifth conductor pattern 25a5 is connected at one end thereof to the via conductor V4 and is connected at the other end P2 thereof to the second connecting portion 25e. The magnetic film 11e has a through hole extending therethrough in the T-axis direction at the region overlapping with the via conductor V4, and the via conductor V4 is embedded in this through hole.

Each of the magnetic films 11a to 11e has a through hole extending therethrough in the T-axis direction at the region overlapping with the second lead-out portion 25c, and via conductors which constitute the second lead-out portion 25c are embedded in these through holes.

In the illustrated embodiment, the first to fifth tracks 01 to 05 all have an elliptical shape. The shape of the first to fifth tracks 01 to 05 is not limited to an elliptical shape. For example, the first and second tracks 01 and 02 may have an oval, circular, rectangular, polygonal, or other shape in plan view.

The inner diameters of the first and fifth conductor patterns 25a1 and 25a5 are both larger than the inner diameters of the second to fourth conductor patterns 25a2 to 25a4. For example, the inner diameter d1, which indicates the inner diameter of the first conductor pattern 25a1 in the L-axis direction, and the inner diameter d5 of the fifth conductor pattern 25a5 are larger than the inner diameter d3 of the second to fourth conductor patterns 25a2 to 25a4.

Thus, the winding portion 25a is constituted by the first to fifth conductor patterns 25a1 to 25a5 and the via conductors V1 to V4. The winding portion 25a is connected at one end P1 thereof to the first connecting portion 25d and is connected at the other end P2 thereof to the second connecting portion 25e.

As shown in FIG. 3E, in plan view (viewed along the T-axis direction), the first half-line HL1, which connects the one end P1 of the winding portion 25a to the coil axis Ax, and the second half-line HL2, which connects the other end P2 of the winding portion 25a to the coil axis Ax, form the first angle α. In other words, the second half-line HL2 is at the position reached by the first half-line HL1 rotated counterclockwise around the coil axis Ax by the first angle α. In plan view, in the region of the winding portion 25a corresponding to the first angle α formed between the first and second half-lines HL1 and HL2, five layers of conductor patterns overlap in the T-axis direction, whereas in the other region (the region corresponding to the major angle (360°−α) defined by the first and second half-lines HL1 and HL2), only four layers of conductor patterns are present. Thus, the multilayer region of the winding portion 25a corresponding to the first angle α contains one more layer of conductor pattern than the other region. Since the multilayer region contains one more layer of conductor pattern than the other region, the magnetic flux concentrates around the multilayer region when the current flowing in the winding portion 25a changes. In one aspect, the region where the magnetic flux concentrates can be made smaller with the first angle α less than 180°. The coil conductor of a conventional coil component is configured so that the number of layers of conductor pattern is larger by one in the region that occupies a half of the winding portion of the coil conductor in the circumferential direction (the region for the angle of 180° corresponding to the first angle α). Therefore, in the coil component 1 with the first angle α less than 180°, the area of the multilayer region where the magnetic flux concentrates can be reduced, thus reducing the magnetic loss in the base body 10. In another aspect, the first angle α is less than 100°. With the first angle α less than 100°, the magnetic loss in the base body 10 can be further reduced.

### (1-4-3) Manufacturing Method

Next, a description is given of an example of a manufacturing method of the coil component 1. The coil component 1 can be manufactured by, for example, a lamination process. An example is hereinafter described of the manufacturing method of the coil component 1 by the sheet lamination.

The first step is to fabricate magnetic sheets as precursors of the magnetic films 11a to 11e, the first low permeability portion 12a, the second low permeability portion 12b, the first cover portion 13a, and the second cover portion 13b that constitute the base body 10. The magnetic sheets are fabricated as follows. For example, metal magnetic powder is mixed and kneaded with a resin to prepare a slurry. The slurry is then applied to a surface of a plastic base film using the doctor blade technique or any other common methods and dried, and the dried slurry is cut to a predetermined size. In the magnetic sheets fabricated in this way, a plurality of metal magnetic particles are dispersed in the resin. When fabricating the magnetic sheets as precursors of the first low permeability portion 12a and the second low permeability portion 12b, metal magnetic particles are used that have a smaller average particle size than the metal magnetic particles used in fabricating the magnetic sheet as the precursor of the magnetic film 11c. Therefore, the average particle size of the metal magnetic particles contained in the magnetic sheet as the precursor of the first low permeability portion 12a is smaller than the average particle size of the metal magnetic particles in each of the magnetic sheets as the precursors of the magnetic film 11c, the first cover portion 13a, and the second cover portion 13b. Similarly, the average particle size of the metal magnetic particles contained in the magnetic sheet as the precursor of the second low permeability portion 12b is smaller than the average particle size of the metal magnetic particles in each of the magnetic sheets as the precursors of the magnetic film 11c, the first cover portion 13a, and the second cover portion 13b.

Next, a through hole is formed in each of the magnetic sheets as the precursors of the magnetic films 11a to 11e, the first low permeability portion 12a, and the first cover portion 13a at a predetermined position so as to extend through the magnetic sheets in the T-axis direction. Following this, a conductive paste is printed by screen printing on the top surface of each of the magnetic sheets as the precursors of the magnetic films 11a to 11e, so that an unfired conductor pattern is formed on each of the magnetic sheets. The through holes formed in the magnetic sheets are filled with the conductive paste. The unfired conductor patterns formed on the magnetic sheets as the precursors of the magnetic films 11a to 11e will be the first to fifth conductor patterns 25a1 to 25a5, respectively, after heating. The conductor patterns can also be formed by any various known methods other than the screen printing. The conductive paste is also filled into the through holes formed in each of the magnetic sheets as the precursors of the first low permeability portion 12a and the first cover portion 13a.

Each of the magnetic sheets as the precursors of the magnetic films 11a to 11e, the first low permeability portion 12a, the second low permeability portion 12b, the first cover portion 13a, and the second cover portion 13b may be a single magnetic sheet or a laminated sheet constituted by multiple magnetic sheets stacked together. Adjusting the number of magnetic sheets makes it possible to adjust the thicknesses of the magnetic films 11a to 11e, the first low permeability portion 12a, the second low permeability portion 12b, the first cover portion 13a, and the second cover portion 13b.

Next, the magnetic sheets as the precursors of the magnetic films 11a to 11e, the first low permeability portion 12a, the second low permeability portion 12b, the first cover portion 13a, and the second cover portion 13b are stacked together to obtain a body laminate. The magnetic sheets stacked together may be bonded together by thermal compression using a pressing machine. Next, the body laminate is diced using a cutter such as a dicing machine or a laser processing machine to obtain a chip laminate. Polishing treatment such as barrel polishing may be performed on the end portions of the chip laminate, if necessary.

Next, the chip laminate is degreased and then subjected to thermal treatment, so that the base body 10 is obtained. The thermal treatment forms an oxide layer on the surface of each of the plurality of metal magnetic particles contained in the magnetic sheets, so that the metal magnetic particles adjacent to each other are bonded together via the oxide layers. The thermal treatment is performed on the chip laminate, for example, at a temperature of 600° C. to 800° C. for a duration of 20 to 120 minutes.

Following this, a conductive paste is applied to the bottom surface 10a of the base body 10 to form the first and second external electrodes 21 and 22. The first and second external electrodes 21 and 22 may include a plated layer. There may be two or more plated layers. The two plated layers may include an Ni plated layer and an Sn plated layer externally provided on the Ni plated layer.

The coil component 1 is obtained in the above-described manner. It is also possible to produce the coil component 1 by the compression molding, thin film processing, slurry build or any other known methods.

A part of the steps included in the above manufacturing method may be skipped as necessary. In the manufacturing method of the coil component 1, steps not described explicitly in this specification may be performed as necessary. A part of the steps included in the manufacturing method of the coil component 1 may be performed in different order within the purport of the present invention. A part of the steps included in the manufacturing method of the coil component 1 may be performed at the same time or in parallel, if possible.

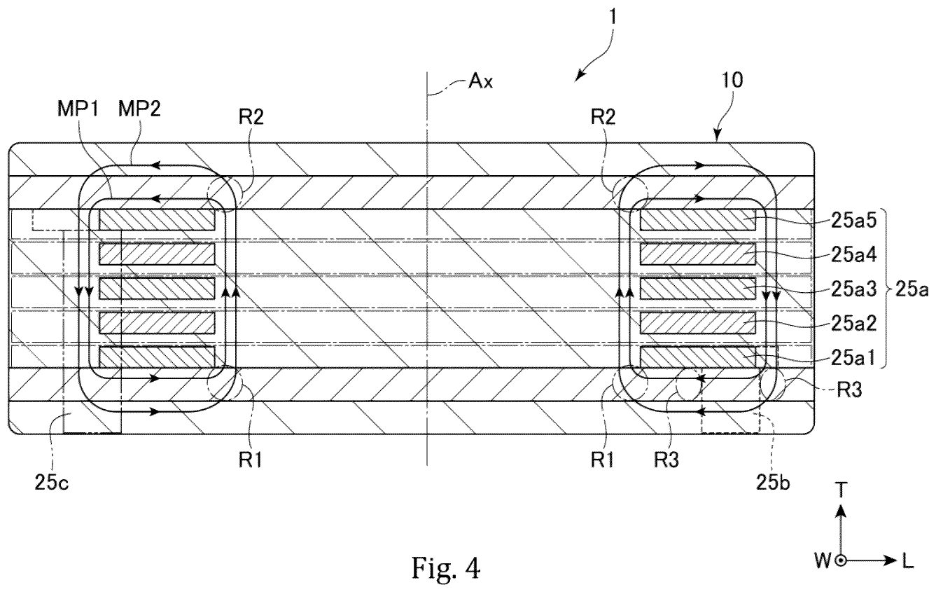

Next, with reference to FIG. 4, a description is given of advantageous effects of the coil component 1. FIG. 4 schematically shows the flows of the magnetic flux with arrows. A magnetic flux tends to travel in a path of small magnetic resistance, and therefore, if the magnetic permeability of the base body 10 is uniform regardless of location, the magnetic flux will attempt to pass through the first magnetic path MP1, which passes in the immediate vicinity of the coil conductor 25. When a large magnetic flux passes through the first magnetic path MP1, the magnetic flux tends to concentrate at the positions where the flux changes its direction in the first magnetic path MP1. In the example shown, the magnetic flux tends to concentrate in the region R1 near the lower end of the inner peripheral surface of the winding portion 25a and the region R2 near the upper end of the same. In the coil component 1, the first low permeability portion 12a covers the bottom surface of the first conductor pattern 25a1, and the second low permeability portion 12b covers the top surface of the fifth conductor pattern 25a5, so that a part of the first magnetic path MP1 is occupied by the low permeability regions. Thus, a larger magnetic flux will flow through the second magnetic path MP2, which is located outside the first magnetic path MP1. The second magnetic path MP2 is located away from the regions near the inner peripheral surfaces of the first and fifth conductor patterns 25a1 and 25a5, and thus the presence of the first and second low permeability portions 12a and 12b in the base body 10 mitigates the concentration of magnetic flux in the regions near the inner peripheral surfaces of the first and fifth conductor patterns 25a1 and 25a5 and further reduces the magnetic loss in the base body 10.

In the base body 10 of the coil component 1, the core center portion relative permeability of the core center portion C2 may be higher than the permeabilities of other regions of the base body 10. In the core center portion C2, the magnetic flux flows along the coil axis Ax, and the direction of the magnetic flux does not change significantly, so that the magnetic flux is less prone to concentrate. Therefore, even if the core center portion relative permeability of the core center portion C2 is increased, magnetic loss due to concentration of magnetic flux is less likely to occur in the core center portion C2. The core center portion relative permeability of the core center portion C2 may be higher than the relative permeabilities of other regions of the base body 10, so that the inductance of the coil component 1 can be improved without increasing the magnetic loss.

In one aspect, the first relative permeability of the first low permeability portion 12a may be lower than the second relative permeability of the second low permeability portion 12b. In the coil component 1, since both the first lead-out portion 25b and the second lead-out portion 25c extend toward the bottom surface 10a, the magnetic flux generated from the current flowing through the first conductor pattern 25a1 and the magnetic flux generated from the current flowing through the first lead-out portion 25b overlap in the region R3 near the connecting position between the first conductor pattern 25a1 and the first lead-out portion 25b, causing the concentration of the magnetic flux in the region R3. In the coil component 1, the bottom surface of the first conductor pattern 25a1 is covered by the first low permeability portion 12a, so that the region R3 is occupied by the first low permeability portion 12a. This arrangement can reduce the magnetic flux passing through the region R3, thereby mitigating the concentration of the magnetic flux in the region R3 and reducing the magnetic loss in the region R3 of the base body 10.

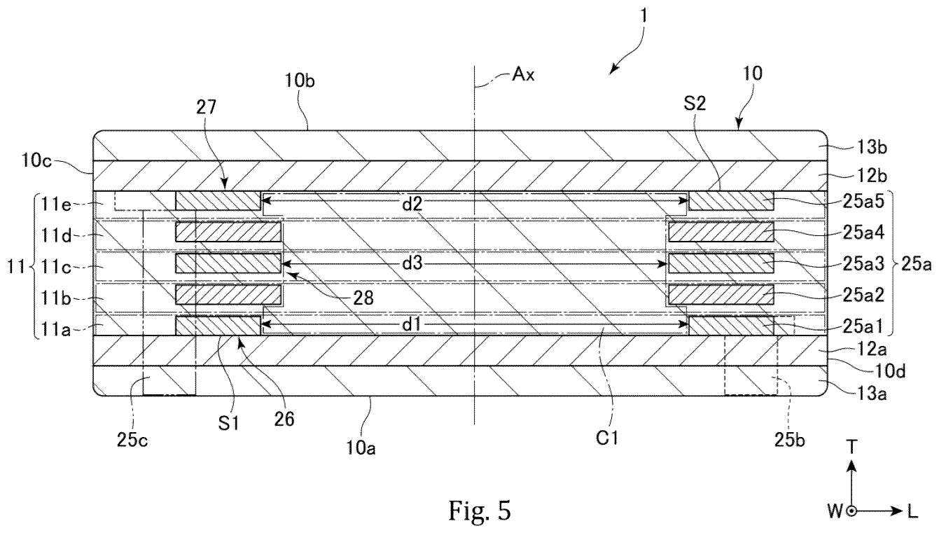

Next, with reference to FIG. 5, a description is given of a variation of the first embodiment. In the aspect shown in FIG. 5, the winding portion 25a is configured as follows. Of the conductor patters constituting the winding portion 25a, the conductor patterns at the ends in the direction along the coil axis Ax (the first conductor pattern 25a1 at the lower end and the fifth conductor pattern 25a5 at the upper end) have a larger inner diameter than the other conductor patterns (the second to fourth conductor patterns 25a2 to 25a4. In the aspect shown in FIG. 5, the first inner diameter d1, which indicates the inner diameter of the first end portion 26 of the winding portion 25a that is close to the one end surface S1, and the second inner diameter d2, which indicates the inner diameter of the second end portion 27 of the winding portion 25a that is close to the other end surface S2, are larger than the third inner diameter d3, which indicates the inner diameter of the central portion 28 of the winding portion 25a positioned between the first end portion 26 and the second end portion 27 in the axial direction. In the aspect shown in FIG. 5, the first end portion 26 of the winding portion 25a that is close to the one end surface S1 includes the first conductor pattern 25a1, and the second end portion 27 of the winding portion 25a that is close to the other end surface S2 includes the fifth conductor pattern 25a5. In the illustrated embodiment, the central portion 28 of the winding portion 25a positioned between the first end portion 26 and the second end portion 27 in the axial direction includes the second to fourth conductor patterns 25a2 to 25a4.

FIG. 5 shows the inner diameters d1, d2, and d3 in a section of the coil component 1 cut in an LT plane, but the inner diameters of the first end portion 26 and the second end portion 27 of the winding portion 25a are still larger than that of the central portion 28 in the section of the coil component 1 cut in the plane passing through the coil axis Ax and parallel to the WT plane.

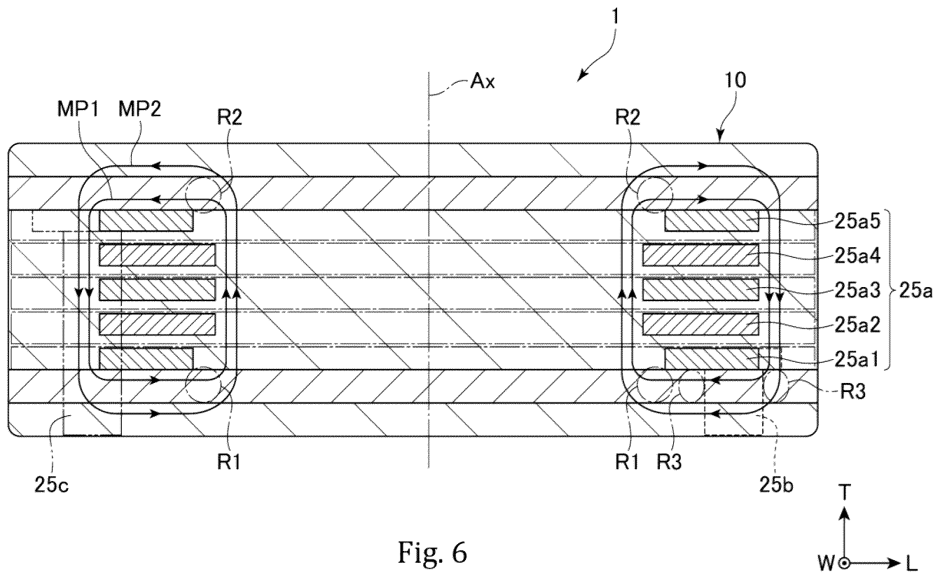

With reference to FIG. 6, a description is given of advantageous effects produced by the coil component 1 shown in FIG. 5. When the current flowing in the coil conductor 25 changes during use of the coil component 1, a magnetic flux is generated around the coil conductor 25. FIG. 6 schematically shows the flows of the magnetic flux with arrows. As described with reference to FIG. 4, the magnetic flux in the example shown in FIG. 6 also tends to concentrate in the region R1 near the lower end of the inner peripheral surface of the winding portion 25a and the region R2 near the upper end of the same. In the coil component 1 shown in FIG. 6, the winding portion 25a is configured such that the inner diameter d1 of the first conductor pattern 25a1 at the lower end of the winding portion 25a and the inner diameter d2 of the fifth conductor pattern 25a5 at the upper end of the winding portion 25a are larger, and this configuration mitigates the concentration of the magnetic flux in the regions R1 and R2 in terms of the geometric arrangement of the conductor patterns constituting the winding portion 25a. In other words, in the coil component 1, the winding portion 25a is configured such that the inner diameter d1 of the first conductor pattern 25a1 and the inner diameter d2 of the fifth conductor pattern 25a5 are larger, thereby mitigating the concentration of the magnetic flux in the regions near the inner peripheral surfaces of the first and fifth conductor patterns 25a1 and 25a5 to reduce the magnetic loss in the base body 10.

### (2) Second Embodiment

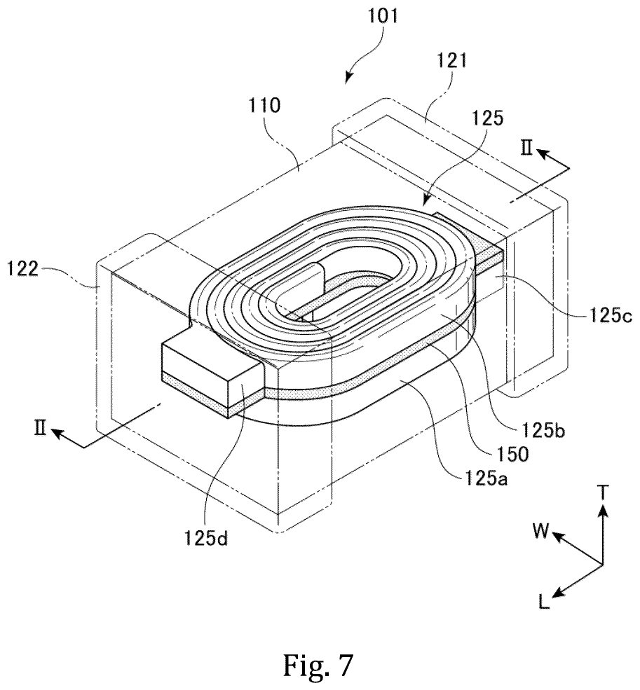

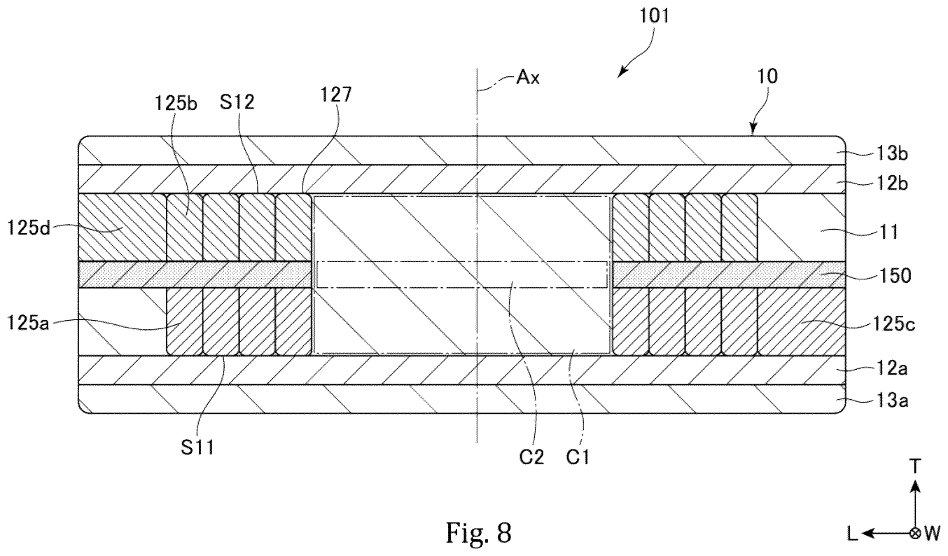

Next, a coil component 101 according to the second embodiment will be described with reference to FIGS. 7 and 8. The coil component 101 is a planar coil. The coil component 101 differs from the coil component 1 in that a coil conductor 125 is provided in the base body 10 instead of the coil conductor 25, and first and second external electrodes 121 and 122 are provided instead of the first and second external electrodes 21 and 22. In the coil component 101 shown in FIGS. 7 and 8, the components that are the same as or similar to those of the coil component 1 shown in FIG. 1 are denoted by reference signs similar to those in FIG. 1, and detailed descriptions thereof are omitted.

As shown in FIG. 7, the coil component 101 includes a base body 10, an insulating plate 150 disposed in the base body 10, a coil conductor 125 disposed in the base body 10 on a top surface and a bottom surface of the insulating plate 150, an external electrode 121 disposed on the base body 10, and an external electrode 122 disposed on the base body 10 and spaced apart from the external electrode 121. The insulating plate 150 is made of an insulating material and shaped like a plate.

As shown in FIG. 8, the base body 10 includes a body portion 11, a first low permeability portion 12a provided on the bottom surface of the body portion 11, a second low permeability portion 12b provided on the top surface of the body portion 11, a first cover portion 13a provided on the bottom surface of the first low permeability portion 12a, and a second cover portion 13b provided on the top surface of the second low permeability portion 12b.

In the embodiment shown, the coil conductor 125 includes a first winding portion 125a formed on the bottom surface of the insulating plate 150 and a second winding portion 125b formed on the top surface of the insulating plate 150. The first winding portion 125a and the second winding portion 125b are connected by a via (not shown). The first winding portion 125a is formed in a predetermined pattern on the bottom surface of the insulating plate 150, and the second winding portion 125b is formed in a predetermined pattern on the top surface of the insulating plate 150. An insulating film may be provided on the surfaces of the first and second winding portions 125a and 125b. The coil conductor 125 can be provided in various shapes.

A first lead-out portion 125c is connected to the radially outer end of the first winding portion 125a. The first lead-out portion 125c is led out to the outside of the base body 10 and is electrically connected to the first external electrode 121. A second lead-out portion 125d is connected to the radially outer end of the second winding portion 125b. The second lead-out portion 125d is led out to the outside of the base body 10 and is electrically connected to the second external electrode 122.

As shown in FIG. 8, one end surface S11 of the coil conductor 125 (the lower end surface of the first winding portion 125a) is covered by the first low permeability portion 12a. The other end surface S12 of the coil conductor 125 (the upper end surface of the second winding portion 125b) is covered by the second low permeability portion 12b. The first relative permeability of the first low permeability portion 12a and the second relative permeability of the second low permeability portion 12b are lower than the core center portion relative permeability of the core center portion C2. Therefore, the coil component 101 of the second embodiment has the same mechanism as described for the coil component 1 of the first embodiment, thereby mitigating the concentration of the magnetic flux in the region near the inner peripheral surface of the lower end of the first winding portion 125a and the region near the inner peripheral surface of the upper end of the second winding portion 125b, and reducing the magnetic loss in the base body 10.

The following describes an example method of manufacturing the coil component 101. To start with, the insulating plate 150 made of a magnetic material and shaped like a plate is prepared. Next, a photoresist is applied to each of the top and bottom surfaces of the insulating plate 150, a conductor pattern is exposed and transferred to each of the top and bottom surfaces of the insulating plate 150, and the photoresist is then developed. In this manner, a resist having an opening pattern for forming the coil conductor 125 is formed on each of the top and bottom surfaces of the insulating plate 150.

Next, each of the opening patterns is filled with electrically conductive metal by plating. Next, the resists are removed from the insulating plate 150 by etching to form the first winding portion 125a on the bottom surface of the insulating plate 150 and form the second winding portion 125b on the top surface of the insulating plate 150. A through hole formed in the insulating plate 150 is filled with a conductive paste to form the via connecting the first winding portion 125a and the second winding portion 125b.

Next, the base body 10 is formed on both of the sides of the insulating plate 150 having the coil conductor 125 formed thereon. To form the base body 10, magnetic sheets are fabricated as precursors of the body portion 11, the first low permeability portion 12a, the second low permeability portion 12b, the first cover portion 13a, and the second cover portion 13b. Each of the first low permeability portion 12a, the second low permeability portion 12b, the first cover portion 13a, and the second cover portion 13b may be constituted by either a single magnetic sheet or multiple magnetic sheets. The body portion 11 is constituted by a plurality of magnetic sheets.

Next, the magnetic sheets as the precursors of a part (lower part) of the body portion 11, the first low permeability portion 12a, and the first cover portion 13a are stacked together to obtain a first laminate. Also, the magnetic sheets as the precursors of a part (upper part) of the body portion 11, the second low permeability portion 12b, and the second cover portion 13b are stacked together to obtain a second laminate. Next, the first laminate is placed on the lower side of the coil conductor 125, and the second laminate is placed on the upper side of the coil conductor 125. These are heated and pressurized at 5 to 100 MPa to produce a compressed compact containing the coil conductor inside.

Next, the above-described compressed compact is thermally treated. As a result, the base body 10 having the coil conductor 125 therein can be obtained. The thermal treatment cures the resin in the magnetic sheets into a binder, and the binder binds together the metal magnetic particles. The thermal treatment in the thermal treatment step is performed at a temperature equal to or higher than the cure temperature of the resin contained in the resin mixture composition. The thermal treatment in the thermal treatment step is performed at a temperature of, for example, from 100° C. to 200° C. for a duration of 30 minutes to 240 minutes.

Next, a conductor paste is applied to both ends of the base body 10 obtained in the above-described manner to form the external electrodes 121 and 122. The first external electrode 121 is electrically connected to one end of the coil conductor 125 placed within the base body 10, and the second external electrode 122 is electrically connected to the other end of the coil conductor 125 placed within the base body 10. In the above-described manner, the coil component 101 is completed.

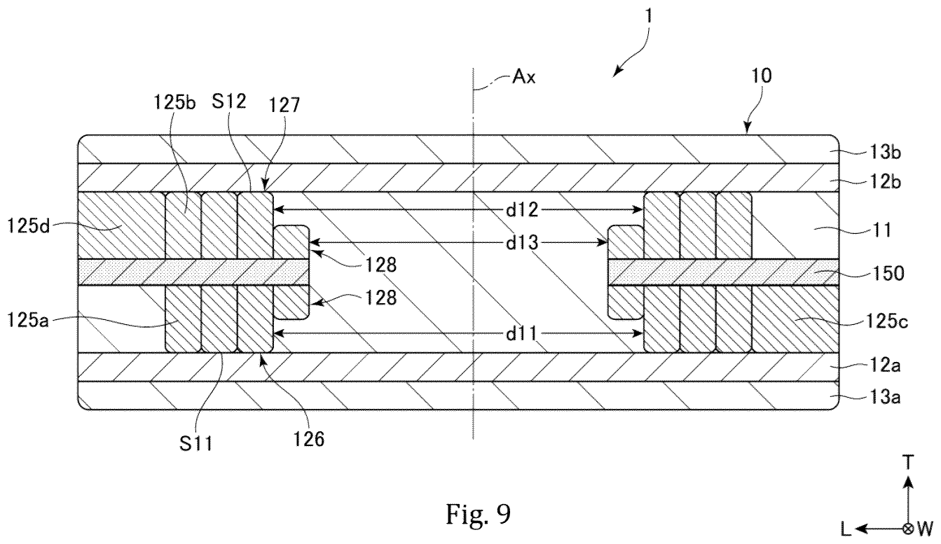

Next, with reference to FIG. 9, a description is given of a variation of the first embodiment. In the aspect shown in FIG. 9, the inner diameter d11 indicating the inner diameter of the first end portion 126 close to the one end surface S11 of the coil conductor 125 (the end surface of the first winding portion 125a) and the inner diameter d12 indicating the inner diameter of the second end portion 127 close to the other end surface S12 of the coil conductor 125 (the end surface of the second winding portion 125b) are larger than the inner diameter d13 indicating the inner diameter of the central portion 128 of the coil conductor 125 positioned between the first end portion 126 and the second end portion 127 in the axial direction.

FIG. 9 shows the inner diameters d11, d12, and d13 in a section of the coil component 1 cut in an LT plane, but the inner diameters of the first end portion 126 and the second end portion 127 of the winding portion 25a are still larger than that of the central portion 128 in the section of the coil component 1 cut in the plane passing through the coil axis Ax and parallel to the WT plane.

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A coil component comprising:
a base body (10) containing a plurality of metal magnetic particles;
a coil conductor (25) including a winding portion (25a) provided in the base body and wound around a coil axis (Ax),
wherein the base body includes a core portion (C1), one end portion (12a), and another end portion (12b), the core portion being positioned inside the winding portion in a radial direction around the coil axis, the one end portion covering one end surface (S1) of the winding portion in an axial direction along the coil axis, the other end portion covering another end surface (S2) of the winding portion opposed to the one end surface, and
wherein a first average particle size, which indicates an average particle size of first metal magnetic particles contained in the one end portion among the plurality of metal magnetic particles, and a second average particle size, which indicates an average particle size of second metal magnetic particles contained in the other end portion among the plurality of metal magnetic particles, are smaller than a third average particle size, which indicates an average particle size of third metal magnetic particles contained in a core center portion positioned at a center of the core portion in the axial direction among the plurality of metal magnetic particles.

### Additional Embodiment 2

The coil component of Additional Embodiment 1,
wherein the one end portion has a first relative permeability that is lower than a core center portion relative permeability of the core center portion and
wherein the other end portion includes a second low permeability portion having a second relative permeability that is lower than the core center portion relative permeability.

### Additional Embodiment 3

The coil component of Additional Embodiment 1 or 2, wherein a first dimension of the base body in the axial direction is smaller than a second dimension of the base body in a direction perpendicular to the axial direction.

### Additional Embodiment 4

The coil component of any one of Additional Embodiments 1 to 3, wherein a first inner diameter (d1), which indicates an inner diameter of a first end portion of the winding portion that is close to the one end surface, and a second inner diameter (d2), which indicates an inner diameter of a second end portion of the winding portion that is close to the other end surface, are larger than a third inner diameter (d3), which indicates an inner diameter of a central portion of the winding portion positioned between the first end portion and the second end portion in the axial direction.

### Additional Embodiment 5

The coil component of any one of Additional Embodiments 1 to 4, wherein in a view along the axial direction, a first angle (a) formed between a first half-line (HL1) and a second half-line (HL2) toward a direction from one end of the winding portion to another end of the winding portion is less than 180°, the first half-line connecting the one end of the winding portion to the coil axis, the second half-line connecting the other end of the winding portion to the coil axis.

### Additional Embodiment 6

The coil component of any one of Additional Embodiments 1 to 5, wherein the first angle is less than 110°.

### Additional Embodiment 7

The coil component of any one of Additional Embodiments 1 to 6, further comprising:
a first lead-out portion (25b) electrically connected to one end of the winding portion and extending along the coil axis to a first surface of the base body; and
a second lead-out portion (25c) electrically connected to another end of the winding portion and extending along the coil axis to the first surface of the base body,
wherein the one end portion is located between the first surface of the base body and the one end surface of the winding portion, and
wherein the first relative permeability is lower than the second relative permeability.

### Additional Embodiment 8

The coil component of any one of Additional Embodiments 1 to 7, further comprising:
a first external electrode (21) electrically connected to the first lead-out portion; and
a second external electrode (22) electrically connected to the second lead-out portion.

### Additional Embodiment 9

The coil component of any one of Additional Embodiments 1 to 8, wherein the base body includes a first cover portion (13a) and a second cover portion (13b), the first cover portion being provided on an opposite side to the core portion with respect to the one end portion in the axial direction and having a third relative permeability higher than the first relative permeability, the second cover portion being provided on an opposite side to the core portion with respect to the other end portion in the axial direction and having a fourth relative permeability higher than the second relative permeability.

What is claimed is:

1. A coil component comprising:
a base body containing a plurality of metal magnetic particles; and
a coil conductor including a winding portion provided in the base body and wound around a coil axis,
wherein the base body includes a core portion, one end portion, and another end portion, the core portion being positioned inside the winding portion in a radial direction around the coil axis, the one end portion covering one end surface of the winding portion in an axial direction along the coil axis, the other end portion covering another end surface of the winding portion opposed to the one end surface, and
wherein a first average particle size, which indicates an average particle size of first metal magnetic particles contained in the one end portion among the plurality of metal magnetic particles, and a second average particle size, which indicates an average particle size of second metal magnetic particles contained in the other end portion among the plurality of metal magnetic particles, are smaller than a third average particle size, which indicates an average particle size of third metal magnetic particles contained in a core center portion positioned at a center of the core portion in the axial direction among the plurality of metal magnetic particles.

2. The coil component of claim 1,
wherein the one end portion has a first relative permeability that is lower than a core center portion relative permeability of the core center portion, and
wherein the other end portion includes a second low permeability portion having a second relative permeability that is lower than the core center portion relative permeability.

3. The coil component of claim 1, wherein a first dimension of the base body in the axial direction is smaller than a second dimension of the base body in a direction perpendicular to the axial direction.

4. The coil component of claim 1, wherein a first inner diameter, which indicates an inner diameter of a first end portion of the winding portion that is close to the one end surface, and a second inner diameter, which indicates an inner diameter of a second end portion of the winding portion that is close to the other end surface, are larger than a third inner diameter, which indicates an inner diameter of a central portion of the winding portion positioned between the first end portion and the second end portion in the axial direction.

5. The coil component of claim 1, wherein in a view along the axial direction, a first angle formed between a first half-line and a second half-line toward a direction from one end of the winding portion to another end of the winding portion is less than 180°, the first half-line connecting the one end of the winding portion to the coil axis, the second half-line connecting the other end of the winding portion to the coil axis.

6. The coil component of claim 5, wherein the first angle is less than 110°.

7. The coil component of claim 2, further comprising:
a first lead-out portion electrically connected to one end of the winding portion and extending along the coil axis to a first surface of the base body; and
a second lead-out portion electrically connected to another end of the winding portion and extending along the coil axis to the first surface of the base body,
wherein the one end portion is located between the first surface of the base body and the one end surface of the winding portion, and
wherein the first relative permeability is lower than the second relative permeability.

8. The coil component of claim 7, further comprising:
a first external electrode electrically connected to the first lead-out portion; and
a second external electrode electrically connected to the second lead-out portion.

9. The coil component of claim 2, wherein the base body includes a first cover portion and a second cover portion, the first cover portion being provided on an opposite side to the core portion with respect to the one end portion in the axial direction and having a third relative permeability higher than the first relative permeability, the second cover portion being provided on an opposite side to the core portion with respect to the other end portion in the axial direction and having a fourth relative permeability higher than the second relative permeability.
